(19) United States
(12) Patent Application Publication
(10) Pub. No.: US 2023/0289406 A1
(43) Pub. Date: Sep. 14, 2023

(54) COMPUTER-READABLE RECORDING MEDIUM STORING DETERMINATION PROGRAM, APPARATUS, AND METHOD

(71) Applicant: Fujitsu Limited, Kawasaki-shi (JP)

(72) Inventors: Takashi KATOH, Kawasaki (JP); Kento UEMURA, Kawasaki (JP); Suguru YASUTOMI, Kawasaki (JP)

(73) Assignee: Fujitsu Limited, Kawasaki-shi (JP)

(21) Appl. No.: 18/177,189

(22) Filed: Mar. 2, 2023

(30) Foreign Application Priority Data
Mar. 8, 2022 (JP) 2022-035576

(51) Int. Cl. G06F 18/2415; G06F 18/2431

(52) U.S. Cl. CPC G06F 18/2415; G06F 18/2431

(57) ABSTRACT

A non-transitory computer-readable recording medium stores a determination program for causing a computer to execute processing including: re-training a classification model that has been trained by using a first data set and that classifies input data into any one of a plurality of classes by using a loss calculatable based on a second data set that is different from the first data set; and determining, in a case where a change in a classification standard of the classification model based on the loss is a predetermined standard or more before and after re-training, that unknown data that is not classified into any one of the plurality of classes is included in the second data set.

### CROSS-REFERENCE TO RELATED APPLICATION

This application is based upon and claims the benefit of priority of the prior Japanese Patent Application No. 2022-35576, filed on Mar. 8, 2022, the entire contents of which are incorporated herein by reference.

### FIELD

The embodiments discussed herein are related to a determination program, a determination apparatus, and a determination method.

### BACKGROUND

Data of a class not included in learning data used for learning of a classification model that classifies input data into any one of a plurality of classes, so-called unknown data, may be included in data at the time of application of a system using the classification model. In this case, erroneous determination may occur in classification of data by the classification model, and accuracy may deteriorate. Therefore, it is desirable to be able to determine whether or not unknown data is included in the data at the time of application.

Japanese Laid-open Patent Publication No. 2020-047010 is disclosed as related art.

### SUMMARY

According to an aspect of the embodiments, a non-transitory computer-readable recording medium stores a determination program for causing a computer to execute processing including: re-training a classification model that has been trained by using a first data set and that classifies input data into any one of a plurality of classes by using a loss calculatable based on a second data set that is different from the first data set; and determining, in a case where a change in a classification standard of the classification model based on the loss is a predetermined standard or more before and after re-training, that unknown data that is not classified into any one of the plurality of classes is included in the second data set.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram of a determination apparatus;

FIG. 2 is a diagram for describing a problem in the case of determining presence or absence of unknown data based on a degree of certainty according to a distance from a determination plane;

FIG. 3 is a diagram for describing the problem in the case of determining presence or absence of unknown data based on the degree of certainty according to the distance from the determination plane;

FIG. 4 is a diagram for describing an outline of the present embodiment;

FIG. 5 is a diagram for describing re-learning of a classification model and determination of presence or absence of unknown data in a first embodiment;

FIG. 6 is a block diagram illustrating a schematic configuration of a computer that functions as the determination apparatus;

FIG. 7 is a flowchart illustrating an example of determination processing in the first embodiment;

FIG. 8 is a diagram for describing a specific example of the determination processing;

FIG. 9 is a diagram for describing the specific example of the determination processing;

FIG. 10 is a diagram for describing the specific example of the determination processing;

FIG. 11 is a diagram for describing the specific example of the determination processing;

FIG. 12 is a diagram for describing the specific example of the determination processing;

FIG. 13 is a diagram for describing re-learning of a classification model and determination of presence or absence of unknown data in a second embodiment;

FIG. 14 is a flowchart illustrating an example of determination processing in the second embodiment; and

FIG. 15 illustrates a diagram for describing an effect of a proposed method.

### DESCRIPTION OF EMBODIMENTS

As a technology related to the determination of the data at the time of application, for example, an information estimation device that determines whether or not data to be estimated input to an autoencoder is learned data has been proposed. In this device, an encoder that performs estimation processing by using a neural network is used. The encoder is provided with, as a final layer, at least one integrated layer including a combination of a dropout layer that drops out a part of the data and a fully connected layer that calculates a weight for the data output from the dropout layer. The encoder outputs a multidimensional random variable vector as an output value in latent space. Furthermore, this device analytically calculates a probability distribution followed by the output value in the latent space output by the encoder as a multivariate Gaussian mixture distribution, and determines whether or not input data is learned data based on a feature of the analytically calculated multivariate Gaussian mixture distribution.

At the time of application of a machine-learned model, learning data used for machine learning of the model may not remain. For example, in a business setting using customer data, it is often not permitted under contract or in terms of a risk of information leakage to retain certain customer data for a long time or to reuse a machine-learned model using the customer data for another customer's task. Furthermore, the prior art described above is usually a technology corresponding to anomaly detection, and is not for determining whether or not unknown data not included in the learning data used for learning of the classification model is included in the data at the time of application.

As one aspect, the disclosed technology aims to accurately determine whether or not unknown data is included in data at the time of application of a classification model.

Hereinafter, an example of embodiments according to the disclosed technology will be described with reference to the drawings.

### First Embodiment

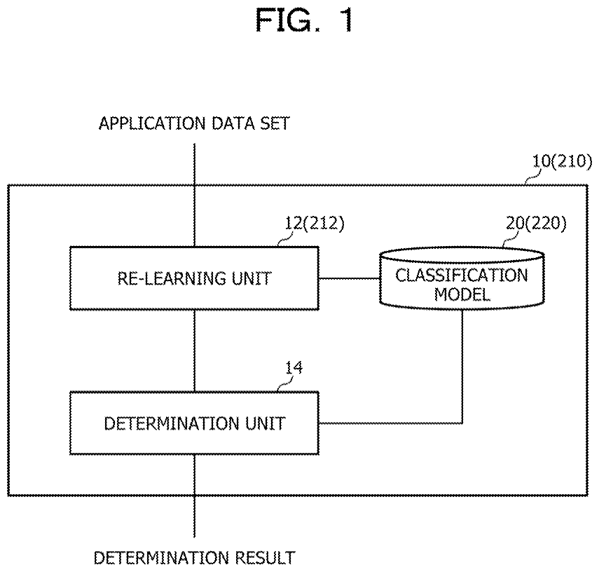

As illustrated in FIG. 1, in a determination apparatus 10 according to a first embodiment, a machine-learned classification model 20 that classifies input data into any one of a plurality of classes is stored. Furthermore, a data set (hereinafter referred to as “application data set”) of data (hereinafter referred to as “application data”) input at the time of application of a system using the classification model 20 is input to the determination apparatus 10. Then, the determination apparatus 10 determines whether or not data of a class not included in learning data used for machine learning of the classification model 20, so-called unknown data, is included in the application data set, and outputs a determination result.

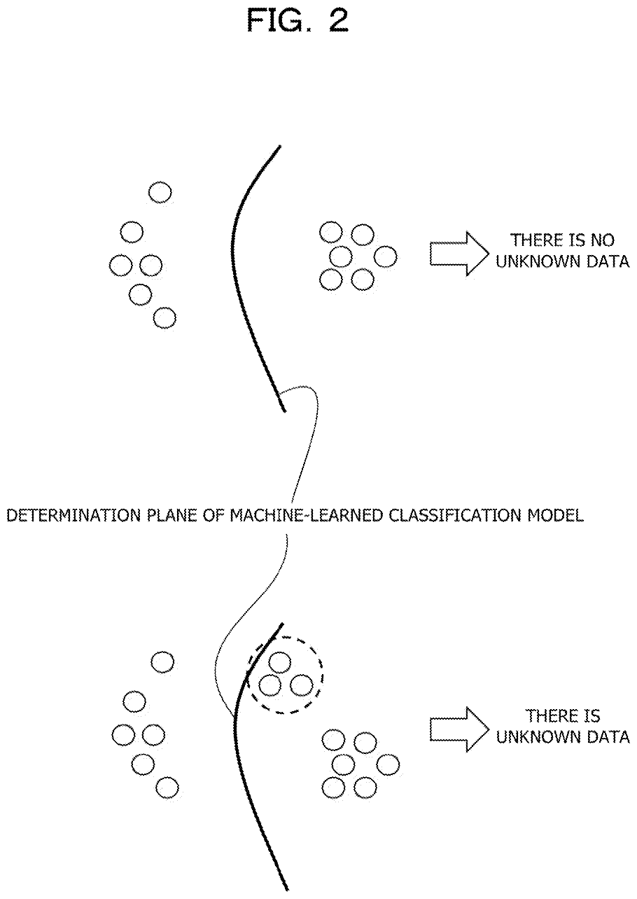

Here, as a method of determining whether or not unknown data is included in the application data set, a method may be considered in which a degree of certainty based on a distance from a determination plane indicating a boundary of each class in the machine-learned classification model is calculated for each piece of the application data. In this case, the closer the distance from the determination plane is, the lower the degree of certainty is calculated. Then, as illustrated in an upper diagram of FIG. 2, in a case where the number of pieces of data with a low degree of certainty is less than a certain number, it is determined that unknown data is not included in the application data set. On the other hand, as illustrated in a lower diagram of FIG. 2, in a case where there is a certain number or more of the data with a low degree of certainty (a broken line part in FIG. 2), it is determined that unknown data is included in the application data set. Note that, in FIG. 2, a circle represents each piece of the application data. The same applies to each of the following drawings.

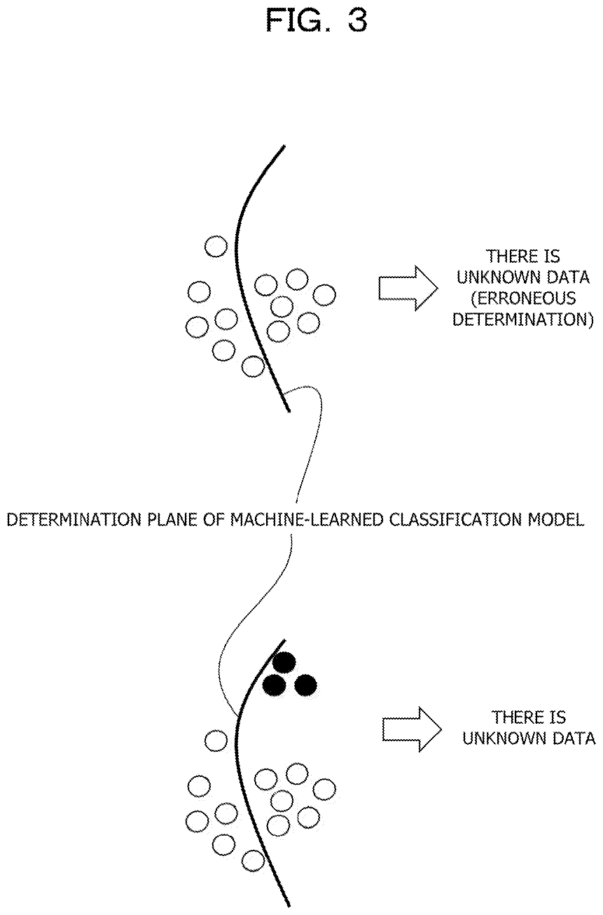

In the case of the method described above, as illustrated in a lower diagram of FIG. 3, in a case where unknown data (black circles in FIG. 3) is actually included in the vicinity of the determination plane, it is determined that unknown data is included in the application data set. However, as illustrated in an upper diagram of FIG. 3, in a case where pieces of application data for which a class to be classified is known are concentrated in the vicinity of the determination plane, it is erroneously determined that unknown data is included in the application data set even in a case where there is no unknown data.

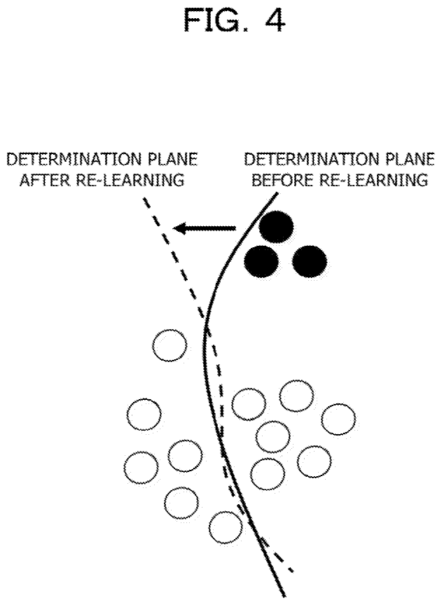

Thus, in the present embodiment, it is assumed that the machine-learned classification model is optimized to a known class for the learning data, a class corresponding to unknown data appears in addition to the known class, and a distribution of the known class does not change. Additionally, under this assumption, the present embodiment focuses on a point that the classification model changes when re-learning of the classification model is performed with a data set including unknown data in a case where a label is given to the application data. For example, as illustrated in FIG. 4, there is a high possibility that an application data set in which the determination plane of the classification model greatly changes before and after re-learning includes unknown data. Therefore, in the present embodiment, each piece of the application data included in the application data set is labeled in some way, for example, re-learning of the classification model using the application data is performed, and presence or absence of unknown data in the application data set is determined based on changes in the classification model before and after the re-learning.

The determination apparatus 10 functionally includes a re-learning unit 12 and a determination unit 14, as illustrated in FIG. 1.

The re-learning unit 12 re-learns, by using a loss that may be calculated based on the application data set, the classification model 20 that has been learned by using the learning data set and that classifies input data into any one of a plurality of classes. Note that the learning data set is an example of a first data set of the disclosed technology, and the application data set is an example of a second data set of the disclosed technology.

For example, the re-learning unit 12 sets a classification result of the application data by the classification model 20 before the re-learning as a correct answer, and executes the re-learning of the classification model 20 by using a loss indicating an error between the classification result of the application data by the classification model 20 after the re-learning and the correct answer.

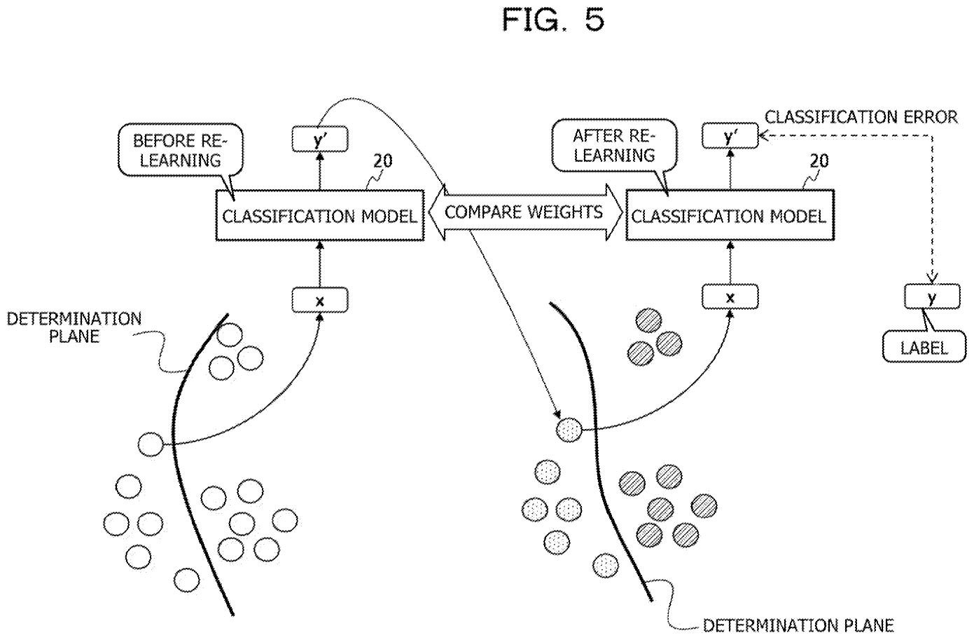

For example, as illustrated in FIG. 5, the re-learning unit 12 sets the application data as input data x and inputs the input data x to the classification model 20 before the re-learning, and obtains an output y′ of the classification model 20. The output y′ is, for example, a probability that the input data belongs to each class classifiable by the classification model 20. The re-learning unit 12 assigns a label to the application data, which is the input data x, based on the output y′. For example, the re-learning unit 12 assigns, to the application data, a label indicating a class with the maximum probability indicated by the output y′. In the example of FIG. 5, it is represented that labels indicating a class 1 (for example, a positive example) are assigned to application data indicated by shaded circles, and labels indicating a class 2 (for example, a negative example) are assigned to application data indicated by hatched circles.

Then, the re-learning unit 12 executes the re-learning of the classification model 20 by supervised learning using the labeled application data. For example, the re-learning unit 12 updates a weight that specifies the determination plane of the classification model 20 so as to minimize a classification error between the output y′ obtained by inputting the application data to the classification model 20 as the input data x and the label assigned to the application data. Note that the weight is an example of a classification standard of the disclosed technology.

As illustrated in FIG. 5, the determination unit 14 compares the weights of the classification model 20 before and after the re-learning by the re-learning unit 12, and determines that unknown data is included in the application data set in a case where a change in the weight is a predetermined standard or more. The weight specifies the determination plane of the classification model 20, and as illustrated in FIG. 5, in a case where the weight changes, it is represented that the determination plane of the classification model 20 based on a loss changes before and after the re-learning. In a case where a degree of this change is the predetermined standard or more, for example, in a case where the sum of differences between before and after the re-learning for all weights included in the classification model 20 is a predetermined threshold or more, the determination unit 14 determines that unknown data is included in the application data set. On the other hand, in a case where the sum of the weight differences before and after the re-learning is less than the predetermined threshold, the determination unit 14 determines that unknown data is not included in the application data set. The determination unit 14 outputs a determination result indicating presence or absence of unknown data in the application data set.

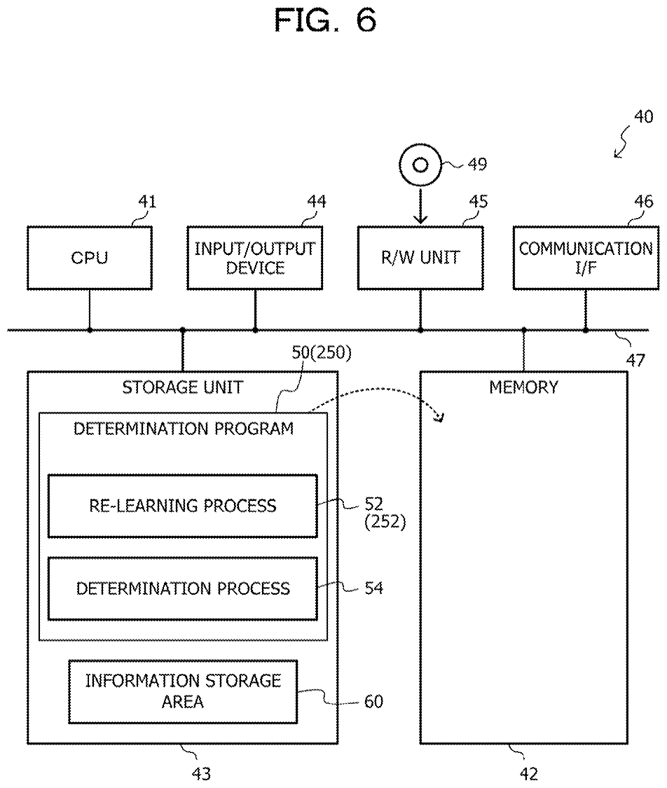

The determination apparatus 10 may be implemented by a computer 40 illustrated in FIG. 6, for example. The computer 40 includes a central processing unit (CPU) 41, a memory 42 as a temporary storage area, and a nonvolatile storage unit 43. Furthermore, the computer 40 includes an input/output device 44 such as an input unit or a display unit, and a read/write (R/W) unit 45 that controls reading and writing of data from/to a storage medium 49. Furthermore, the computer 40 includes a communication interface (I/F) 46 to be connected to a network such as the Internet. The CPU 41, the memory 42, the storage unit 43, the input/output device 44, the R/W unit 45, and the communication I/F 46 are connected to each other via a bus 47.

The storage unit 43 may be implemented by a hard disk drive (HDD), a solid state drive (SSD), a flash memory, or the like. The storage unit 43 as a storage medium stores a determination program 50 for causing the computer 40 to function as the determination apparatus 10. The determination program 50 includes a re-learning process 52 and a determination process 54. Furthermore, the storage unit 43 includes an information storage area 60 in which information constituting the classification model 20 is stored.

The CPU 41 reads the determination program 50 from the storage unit 43, develops the determination program 50 on the memory 42, and sequentially executes the processes included in the determination program 50. The CPU 41 executes the re-learning process 52 to operate as the re-learning unit 12 illustrated in FIG. 1. Furthermore, the CPU 41 executes the determination process 54 to operate as the determination unit 14 illustrated in FIG. 1. Furthermore, the CPU 41 reads information from the information storage area 60, and develops the classification model 20 on the memory 42. With this configuration, the computer 40 that has executed the determination program 50 functions as the determination apparatus 10. Note that the CPU 41 that executes the program is hardware.

Note that functions implemented by the determination program 50 may also be implemented by, for example, a semiconductor integrated circuit, in more detail, an application specific integrated circuit (ASIC) or the like.

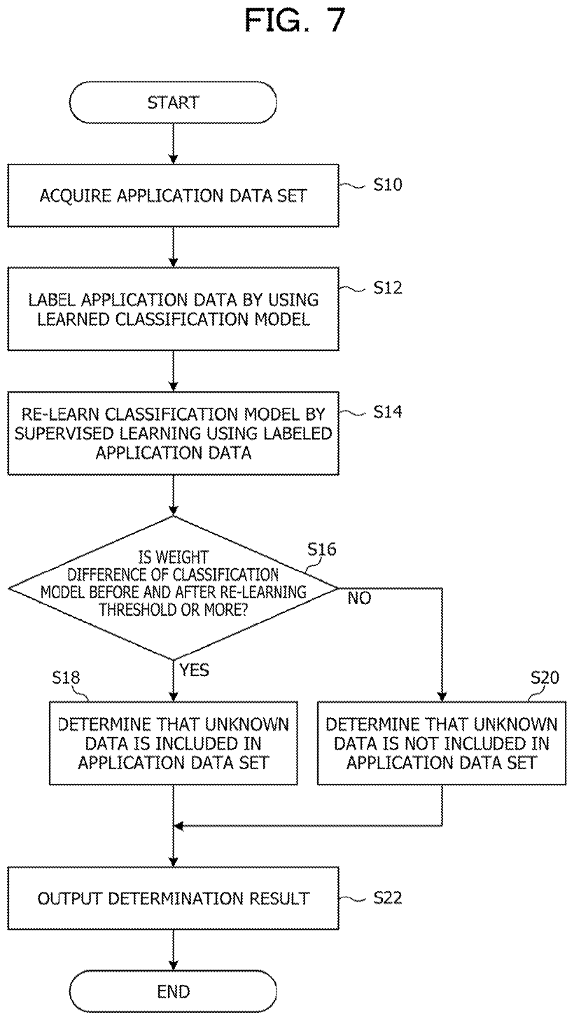

Next, operation of the determination apparatus 10 according to the first embodiment will be described. When the classification model 20 machine-learned by a learning data set is stored in the determination apparatus 10 and an application data set is input to the determination apparatus 10, determination processing illustrated in FIG. 7 is executed in the determination apparatus 10. Note that the determination processing is an example of a determination method of the disclosed technology.

In Step S10, the re-learning unit 12 acquires the application data set input to the determination apparatus 10. Next, in Step S12, the re-learning unit 12 inputs each piece of application data included in the application data set to the classification model 20 before re-learning to obtain an output. Then, the re-learning unit 12 labels the application data based on the output. Next, in Step S14, the re-learning unit 12 executes re-learning of the classification model 20 by supervised learning using the labeled application data.

Next, in Step S16, the determination unit 14 determines whether or not the sum of weight differences of the classification model 20 before and after the re-learning is a predetermined threshold or more. In a case where the sum of the weight differences is the threshold or more, the processing proceeds to Step S18, and in a case where the sum of the weight differences is less than the threshold, the processing proceeds to Step S20. In Step S18, the determination unit 14 determines that unknown data is included in the application data set. On the other hand, in Step S20, the determination unit 14 determines that unknown data is not included in the application data set. Next, in Step S22, the determination unit 14 outputs a determination result in Step S18 or S20 described above, and the determination processing ends.

Next, the determination processing described above will be described more specifically by using a simple example.

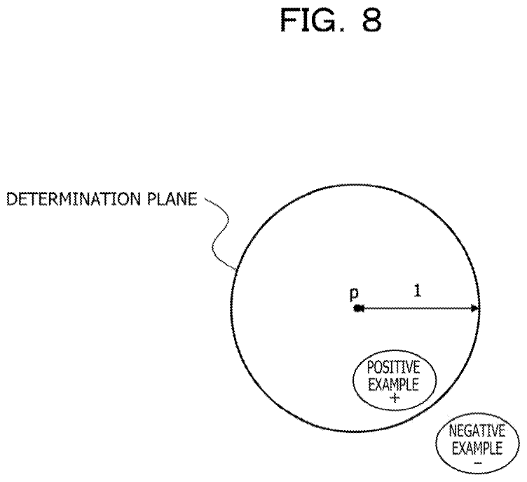

As illustrated in FIG. 8, it is assumed that a plane where a distance from a point p=(x, y) on a two-dimensional plane is 1 is the determination plane, and a model that classifies data whose distance from p is less than 1 as a positive example and data whose distance from p is 1 or more as a negative example is the classification model 20. In learning of this classification model 20, the following sum of losses IL is minimized.

ΣL==Σᵢexp((∥p−aᵢ∥−1)cᵢ)/N

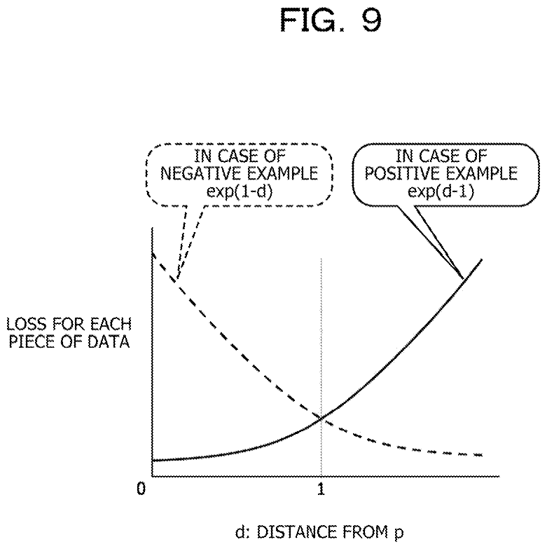

Note that aᵢ is a two-dimensional coordinate of an i-th piece of the learning data, cᵢ is a label of the i-th piece of the learning data (positive example: 1, negative example: −1), and N is the number of pieces of the learning data included in the learning data set. Furthermore, FIG. 9 illustrates a loss for each piece of the learning data according to a distance d from p.

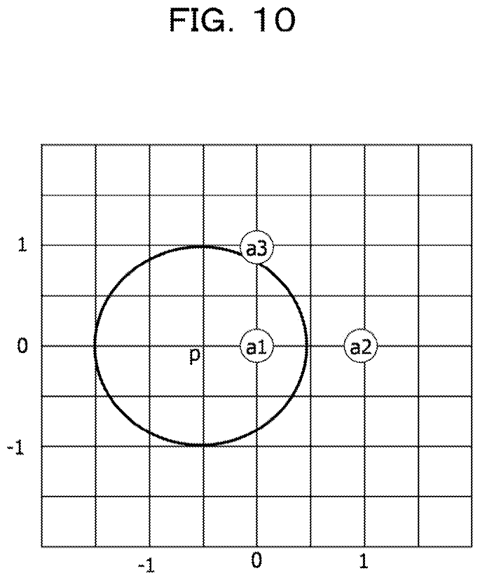

A weight in this classification model 20 is p. As illustrated in FIG. 10, it is assumed that p optimized by machine learning using the learning data set is (−0.5, 0.0). Furthermore, it is assumed that the following application data a1, a2, and a3 are included in the application data set.

a1=(0.0, 0.0)

a2=(1.0, 0.0)

a3=(0.0, 1.0)

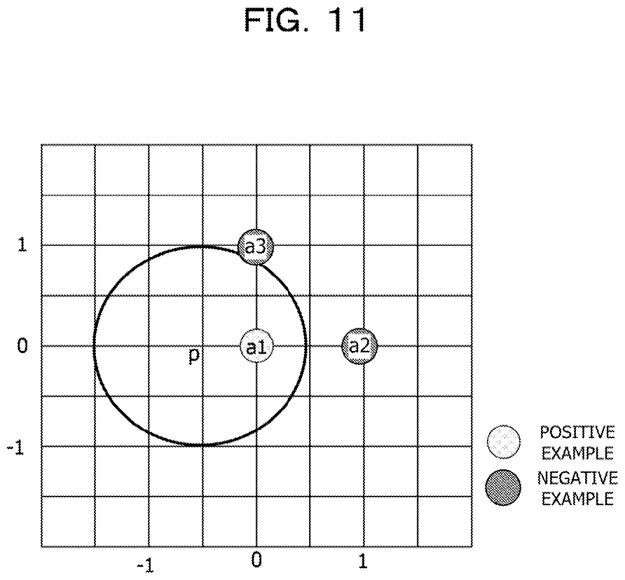

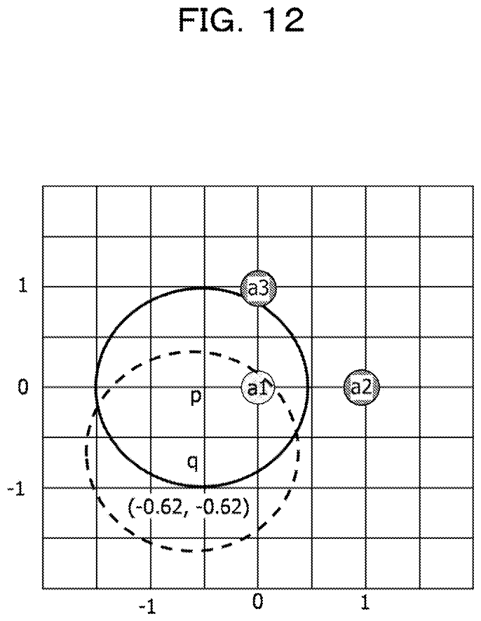

In this case, as illustrated in FIG. 11, a positive example label is assigned to a1 and a negative example label is assigned to a2 and a3 by the re-learning unit 12. It is assumed that the re-learning unit 12 executes re-learning of the classification model 20 by using the application data to which the labels are assigned, so that the weight p=(−0.5, 0.0) is updated to q=(−0.62, −0.62) as illustrated in FIG. 12. In this case, a change in the weight is ∥q—P∥=0.63, and for example, when the threshold is set to 0.5, the change in the weight of 0.63 is the threshold or more, and it is determined that unknown data is included in the application data set.

As described above, the determination apparatus according to the first embodiment re-learns the classification model by using the loss that may be calculated based on the application data set different from the learning data set. The classification model is a classification model that has been learned by using a learning data set, and is a machine learning model that classifies input data into any one of a plurality of classes. Furthermore, in a case where a change in the classification standard of the classification model based on the loss is the predetermined standard or more before and after the re-learning, the determination apparatus determines that unknown data that is not classified into any one of the plurality of classes is included in the application data set. In this way, since presence or absence of unknown data is determined based on the change in the classification model before and after the re-learning, it is possible to accurately determine whether or not unknown data is included in data at the time of application of the classification model.

### Second Embodiment

Next, a second embodiment will be described. Note that, in a determination apparatus according to the second embodiment, similar components to those of the determination apparatus 10 according to the first embodiment are designated by the same reference numerals, and detailed description thereof will be omitted.

A determination apparatus 210 functionally includes a re-learning unit 212 and a determination unit 14, as illustrated in FIG. 1. Furthermore, a classification model 220 is stored in a predetermined storage area of the determination apparatus 210. The classification model 220 includes a feature extractor that extracts a feature amount from input data, and a classifier that classifies the input data into any one of a plurality of classes based on the extracted feature amount.

The re-learning unit 212 learns a restorer that restores each piece of application data from an output or an intermediate output when each piece of the application data included in an application data set is input to the classification model 220 before re-learning. Then, the re-learning unit 212 executes re-learning of the classification model 220 by using a loss indicating a reconstruction error between the application data set and data restored by the restorer.

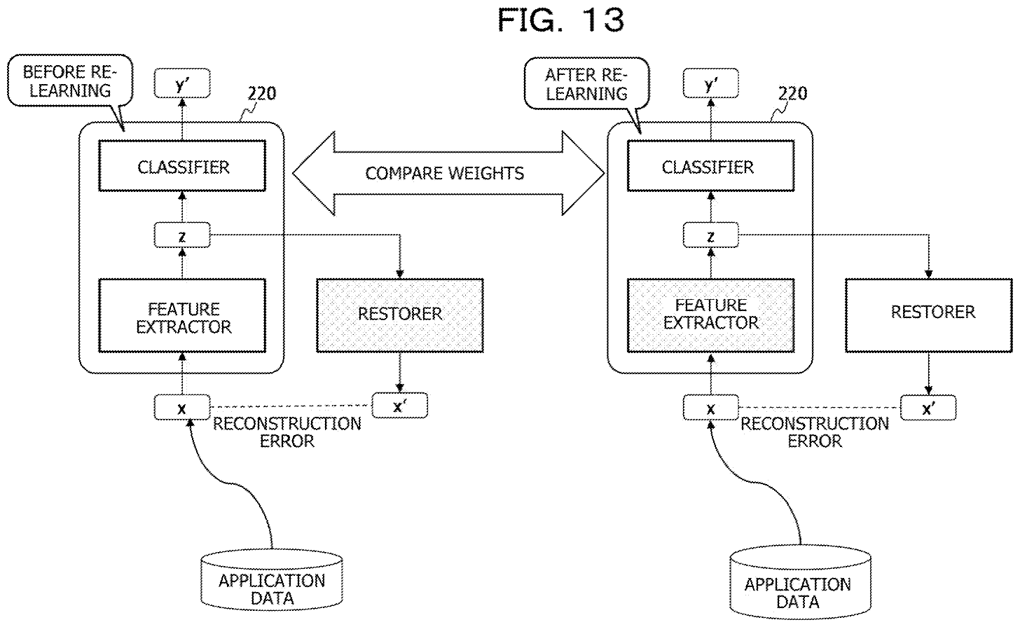

For example, as illustrated in FIG. 13, the re-learning unit 212 sets the application data as input data x and inputs the input data x to the classification model 220 before the re-learning, and obtains an intermediate output z that is a feature amount of the input data x extracted by the feature extractor. The re-learning unit 212 learns the restorer so as to minimize a reconstruction error between data x′ obtained by restoring the intermediate output z by the restorer and the input data x that is the application data. Then, the re-learning unit 212 sets the application data as the input data x and inputs the input data x to the classification model 220, and obtains the intermediate output z that is the feature amount of the input data x extracted by the feature extractor. The re-learning unit 212 learns the feature extractor so as to minimize the reconstruction error between the data x′ obtained by restoring the intermediate output z by the restorer and the input data x that is the application data.

As in the first embodiment, the determination unit 14 compares weights of the classification model 220 before and after the re-learning by the re-learning unit 212, and determines that unknown data is included in the application data set in a case where a change in the weight is a predetermined standard or more. In the second embodiment, since re-learning of the feature extractor between the classifier and the feature extractor of the classification model 220 is executed, the determination unit 14 compares the weights of the feature extractor.

The determination apparatus 210 may be implemented by a computer 40 illustrated in FIG. 6, for example. A storage unit 43 of the computer 40 stores a determination program 250 for causing the computer 40 to function as the determination apparatus 210. The determination program 250 includes a re-learning process 252 and a determination process 54. Furthermore, the storage unit 43 includes an information storage area 60 in which information constituting the classification model 220 is stored.

The CPU 41 reads the determination program 250 from the storage unit 43, develops the determination program 250 on a memory 42, and sequentially executes the processes included in the determination program 250. A CPU 41 executes the re-learning process 252 to operate as the re-learning unit 212 illustrated in FIG. 1. Furthermore, the CPU 41 executes the determination process 54 to operate as the determination unit 14 illustrated in FIG. 1. Furthermore, the CPU 41 reads information from the information storage area 60, and develops the classification model 220 on the memory 42. With this configuration, the computer 40 that has executed the determination program 250 functions as the determination apparatus 210.

Note that the functions implemented by the determination program 250 may also be implemented by, for example, a semiconductor integrated circuit, in more detail, an ASIC or the like.

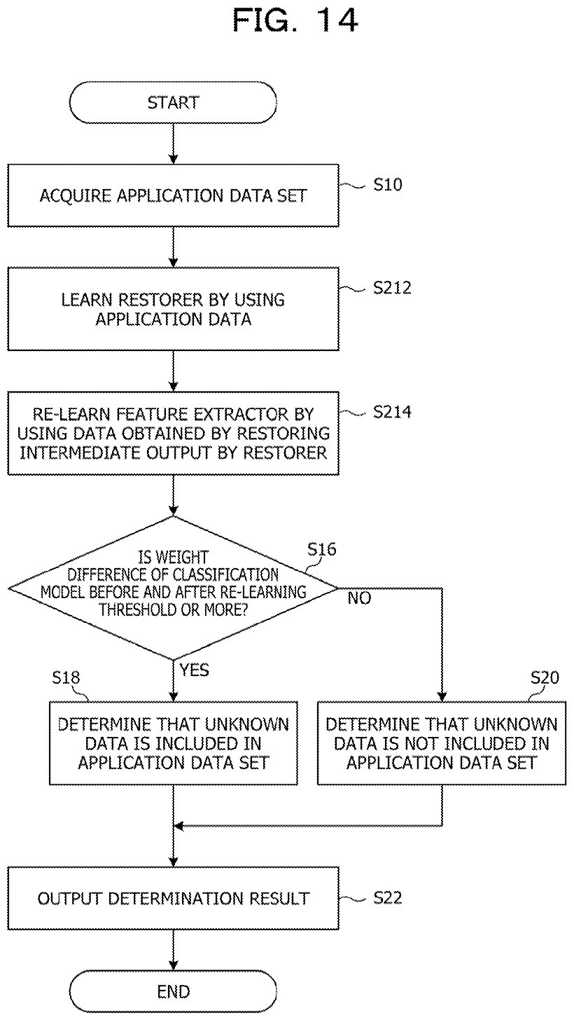

Next, operation of the determination apparatus 210 according to the second embodiment will be described. When the classification model 220 machine-learned by a learning data set is stored in the determination apparatus 210 and an application data set is input to the determination apparatus 210, determination processing illustrated in FIG. 14 is executed in the determination apparatus 210. Note that the determination processing is an example of the determination method of the disclosed technology.

In Step S10, the re-learning unit 212 acquires the application data set input to the determination apparatus 210. Next, in Step S212, the re-learning unit 212 learns the restorer that restores each piece of application data from an intermediate output when each piece of the application data included in the application data set is input to the classification model 220 before re-learning. Next, in Step S214, the re-learning unit 212 executes re-learning of the feature extractor of the classification model 220 by using a loss indicating a reconstruction error between the application data set and data restored by the restorer. Hereinafter, Steps S16 to S22 are executed as in the determination processing in the first embodiment.

As described above, the determination apparatus according to the second embodiment learns the restorer by using the intermediate output of the classification model including the feature extractor and the classifier and the application data, and re-learns the feature extractor by using an output of the learned restorer and the application data. Then, in a case where weight differences of the feature extractor before and after the re-learning is a threshold or more, the determination apparatus determines that unknown data is included in the application data set. With this configuration, as in the first embodiment, it is possible to accurately determine whether or not unknown data is included in data at the time of application of the classification model. For example, in the case of re-learning a classification model for a task in which a difference in data within a class is assumed to be smaller than a difference in data between classes, the method of the second embodiment may be used to more accurately determine presence or absence of unknown data.

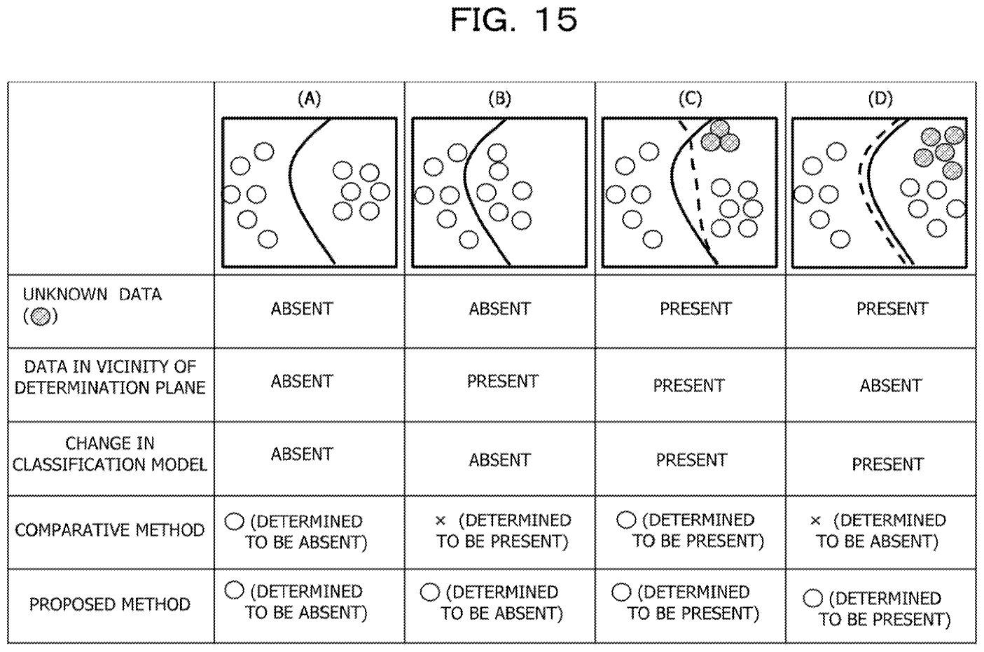

FIG. 15 illustrates a diagram for describing an effect of the first and second embodiments described above. FIG. 15 illustrates four patterns (A, B, C, and D) depending on presence or absence of unknown data in an application data set, presence or absence of application data in the vicinity of a determination plane, and presence or absence of a change in a classification model before and after re-learning. For these four patterns, a comparative method is compared with the method (proposed method) of each of the embodiments described above. Here, the comparative method is the method of calculating a degree of certainty based on a distance from a determination plane for each piece of application data described above.

As illustrated in FIG. 15, for the patterns A and C, both the comparative method and the proposed method may correctly determine presence or absence of unknown data. However, in the comparative method, as indicated in the pattern B, in a case where there is the application data in the vicinity of the determination plane, it is erroneously determined that there is unknown data even though there is no unknown data. On the other hand, according to the proposed method, even when there is the application data in the vicinity of the determination plane, presence or absence of unknown data is determined based on a change in the classification model before and after re-learning, so it is possible to correctly determine that there is no unknown data. Furthermore, in the comparative method, as indicated in the pattern D, in a case where there is no application data in the vicinity of the determination plane, it is erroneously determined that there is no unknown data even though there is unknown data. On the other hand, according to the proposed method, even when there is no application data in the vicinity of the determination plane, presence or absence of unknown data is determined based on a change in the classification model before and after re-learning, so it is possible to correctly determine that there is unknown data.

Note that re-learning may be executed by combining the first embodiment and the second embodiment described above. For example, it is sufficient that the re-learning unit re-learns the classification model so as to minimize a loss represented by the sum or weighted sum of a classification loss in the first embodiment and a reconstruction loss in the second embodiment. In the method of the first embodiment, a loss of unknown data appearing at a position away from the determination plane is reduced, and existence of the unknown data may be less likely to appear as a change in the classification model before and after the re-learning. Even in such a case, presence or absence of unknown data may be determined more accurately by combining the method of the second embodiment.

Furthermore, while a mode in which the determination program is stored (installed) in the storage unit in advance has been described in each of the embodiments described above, the embodiments are not limited to this. The program according to the disclosed technology may be provided in a form stored in a storage medium such as a compact disc read only memory (CD-ROM), a digital versatile disc read only memory (DVD-ROM), or a universal serial bus (USB) memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a determination program for causing a computer to execute processing comprising:
re-training a classification model that has been trained by using a first data set and that classifies input data into any one of a plurality of classes by using a loss calculatable based on a second data set that is different from the first data set; and
determining, in a case where a change in a classification standard of the classification model based on the loss is a predetermined standard or more before and after re-training, that unknown data that is not classified into any one of the plurality of classes is included in the second data set.

2. The non-transitory computer-readable recording medium according to claim 1, wherein the classification standard is a weight that specifies a determination plane that indicates a boundary of each class in the classification model.

3. The non-transitory computer-readable recording medium according to claim 1, wherein, in the processing of re-training, a classification result of each piece of data included in the second data set by the classification model before re-training is set as a correct answer, and re-training of the classification model is executed by using, as the loss, an error between the classification result of each piece of data included in the second data set by the classification model after re-training and the correct answer.

4. The non-transitory computer-readable recording medium according to claim 1, wherein, in the processing of re-training, a restorer that restores each piece of data included in the second data set is trained from an output or an intermediate output when each piece of data included in the second data set is input to the classification model before re-training, and re-training of the classification model is executed by using, as the loss, an error between each piece of data included in the second data set and data restored by the restorer.

5. An information processing apparatus comprising:
a memory; and
a processor coupled to the memory and configured to:
re-train a classification model that has been trained by using a first data set and that classifies input data into any one of a plurality of classes by using a loss calculatable based on a second data set that is different from the first data set; and
determine, in a case where a change in a classification standard of the classification model based on the loss is a predetermined standard or more before and after re-training, that unknown data that is not classified into any one of the plurality of classes is included in the second data set.

6. The information processing apparatus according to claim 5, wherein the classification standard is a weight that specifies a determination plane that indicates a boundary of each class in the classification model.

7. The information processing apparatus according to claim 5, wherein, in the processing of re-training, a classification result of each piece of data included in the second data set by the classification model before re-training is set as a correct answer, and re-training of the classification model is executed by using, as the loss, an error between the classification result of each piece of data included in the second data set by the classification model after re-training and the correct answer.

8. The information processing apparatus according to claim 5, wherein, in the processing of re-training, a restorer that restores each piece of data included in the second data set is trained from an output or an intermediate output when each piece of data included in the second data set is input to the classification model before re-training, and re-training of the classification model is executed by using, as the loss, an error between each piece of data included in the second data set and data restored by the restorer.

9. A determination method comprising:
re-training a classification model that has been trained by using a first data set and that classifies input data into any one of a plurality of classes by using a loss calculatable based on a second data set that is different from the first data set; and
determining, in a case where a change in a classification standard of the classification model based on the loss is a predetermined standard or more before and after re-training, that unknown data that is not classified into any one of the plurality of classes is included in the second data set.

10. The determination method according to claim 9, wherein the classification standard is a weight that specifies a determination plane that indicates a boundary of each class in the classification model.

11. The determination method according to claim 9, wherein, in the processing of re-training, a classification result of each piece of data included in the second data set by the classification model before re-training is set as a correct answer, and re-training of the classification model is executed by using, as the loss, an error between the classification result of each piece of data included in the second data set by the classification model after re-training and the correct answer.

12. The determination method according to claim 9, wherein, in the processing of re-training, a restorer that restores each piece of data included in the second data set is trained from an output or an intermediate output when each piece of data included in the second data set is input to the classification model before re-training, and re-training of the classification model is executed by using, as the loss, an error between each piece of data included in the second data set and data restored by the restorer.
